(19) United States
(12) Patent Application Publication
(10) Pub. No.: US 2002/0112588 A1
(43) Pub. Date: Aug. 22, 2002

(54) Sintered cobalt - containing tungsten- carbide product, and process for making the same

(75) Inventor: Ching-Kwang Lee, Pingtung City (TW)

Correspondence Address: MERCHANT & GOULD PC, P.O. BOX 2903, MINNEAPOLIS, MN, 55402-0903, US

(73) Assignee: Major Industries Ltd.

(21) Appl. No.: 09/746,839

(22) Filed: Dec. 22, 2000

(51) Int. Cl. B26F 1/14

(52) U.S. Cl. 83/684; 419/26

(57) ABSTRACT

A Cobalt-containing tungsten-carbide sintered product includes first and second sintered compacts of Cobalt-containing tungsten-carbide which are integrally formed via a sintering process. One of the first and second sintered compacts has a hardness greater than that of the other one of the first and second sintered compacts.

### BACKGROUND OF THE INVENTION

1. Field of the Invention

This invention relates to a Cobalt-containing tungsten-carbide sintered product and a process for making the same, more particularly to a Cobalt-containing tungsten-carbide sintered product which includes integrally formed sintered compacts that have different hardness and a process for making the same.

2. Description of the Related Art

Punches and dies are generally made from Cobalt-containing tungsten-carbide materials which possess excellent hardness and wear resistance. However, such hardness has an adverse effect on the punches in that the greater the hardness, the more brittle will be the punches. As such, the aforementioned punches tend to break after a period of use. To overcome the aforesaid drawback, a punch can include a metal rod portion and a Cobalt-containing tungsten-carbide portion welded onto the metal rod portion. However, the punch of this type also tends to break at the interface between the metal rod portion and the Cobalt-containing tungsten-carbide portion during a punching operation due to welding stress in the aforesaid interface. A sandwich-type punch has been proposed to overcome this drawback. The sandwich-type punch is modified from the previous punch by including a soft metal portion sandwiched between and welded to the metal rod portion and the Cobalt-containing tungsten-carbide portion. However, the soft metal portion of the punch tends to deform after a period of use.

### SUMMARY OF THE INVENTION

Therefore, it is an object of the present invention to provide a Cobalt-containing tungsten-carbide punch that is capable of overcoming the aforementioned drawbacks.

Another object of the present invention is to provide a process for making the Cobalt-containing tungsten-carbide punch.

According to one aspect of this invention, a Cobalt-containing tungsten-carbide sintered product comprises: first and second sintered compacts of Cobalt-containing tungsten-carbide which are integrally formed via a sintering process. One of the first and second sintered compacts has a hardness greater than that of the other one of the first and second sintered compacts.

According to another aspect of this invention, a process for making a sintered Cobalt-containing tungsten-carbide product comprises the steps of: blending mixtures of Cobalt and tungsten-carbide powders; compressing the mixtures of Cobalt and tungsten-carbide powders to form first and second green compacts; and sintering the first and second green compacts to form first and second sintered compacts which are integrally formed. One of the first and second sintered compacts has a hardness greater than that of the other one of the first and second sintered compacts.

### BRIEF DESCRIPTION OF THE DRAWINGS

In drawings which illustrate an embodiment of the invention,

FIG. 1 is a schematic cross-sectional side view to illustrate formation of a first green compact according to a process for making a sintered product that embodies this invention;

FIG. 2 is a schematic cross-sectional side view to illustrate formation of a second green compact according to the process of this invention;

FIG. 3 is a schematic cross-sectional side view of a sintered compact formed by sintering the first and second green compacts of FIG. 2; and

FIG. 4 is a schematic cross-sectional side view of a punch that includes the sintered compact of FIG. 3 and a rod piece welded to the sintered compact for forming a punch.

### DETAILED DESCRIPTION OF THE PREFERRED EMBODIMENT

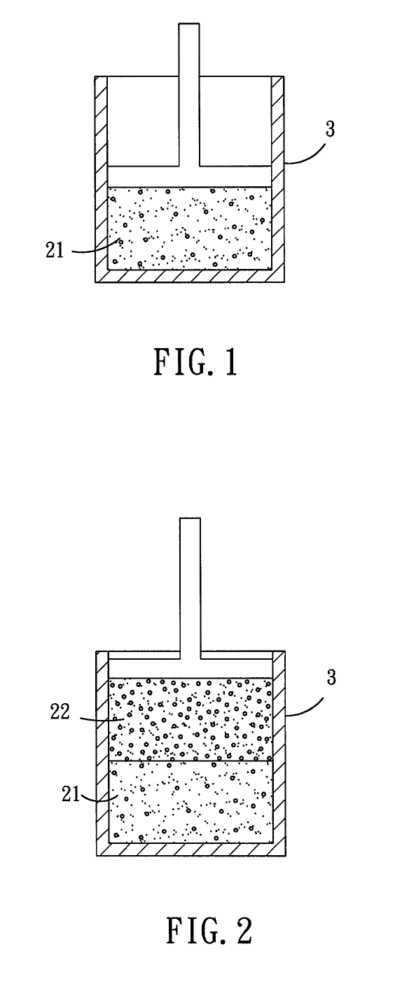

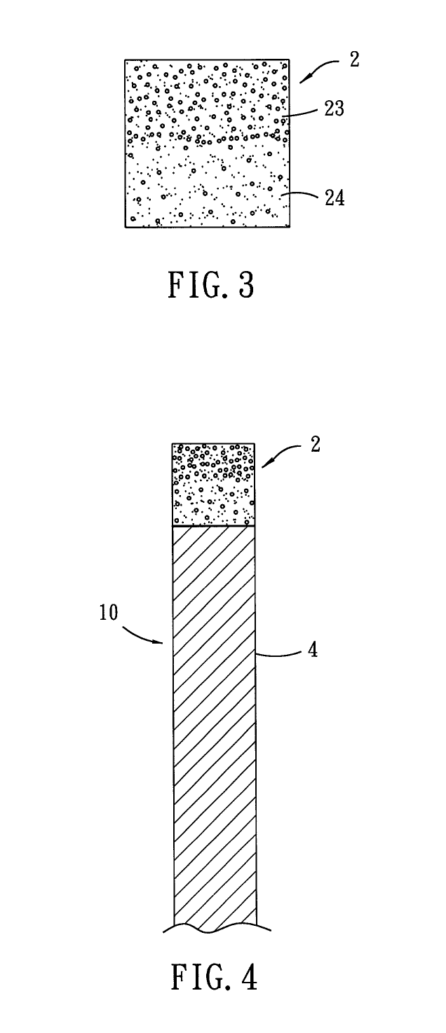

FIGS. 1 to 4 illustrate a process for making a Cobalt-containing tungsten-carbide sintered compact 2 embodying this invention. The sintered compact 2 is then welded to a rod piece 4 to form a punch 10 (see FIG. 4).

The process of this invention includes the steps of: blending mixtures of Cobalt and tungsten-carbide powders; compressing the mixtures of Cobalt and tungsten-carbide powders to form first and second green compacts 21, 22 via a compressing device 3; stacking and placing the first and second green compacts 21, 22 in a mold cavity (not shown); and sintering the first and second green compacts 21, 22 to respectively form first and second sintered compacts 23, 24 which are integrally formed and which are bonded together at an interface that is disposed therebetween. One of the first and second sintered compacts 23, 24 has a hardness greater than that of the other one of the first and second sintered compacts 23, 24. The difference in hardness for the first and second sintered compacts 23, 24 can be accomplished by providing different amounts of Cobalt in the first and second green compacts 21, 22, or by providing different particle sizes of the tungsten-carbide contained in the first and second green compacts 21, 22. The thus formed integral part not only possesses a high degree of hardness, but also has enhanced toughness as compared to that of the prior art. As a consequence, the breakage and deformation problem as encountered in the prior art can be avoided.

The process of this invention can further include a step of pre-sintering the mixtures of Cobalt and tungsten-carbide powders in another mold cavity before the step of forming the first and second green compacts 21, 22 via the compressing operation.

The following Examples 1 to 5 illustrate variations in hardness of the first and second sintered compacts 23, 24 with changes in weight percentage of Cobalt in the first and second green compacts 21, 22, or with changes in particle sizes of the tungsten-carbide in the first and second green compacts 21, 22. The results are listed in Table 1.

TABLE 1

| | | Cobalt | Particle | Hardness, |
|---|---|---|---|---|
| | | wt % | size, μm | HRA |
| Example 1 | 1^{st} sintered | 5 | 0.8 | 90 |
| | compact | | | |
| | 2^{nd} sintered | 15 | 4.0 | 85 |
| | compact | | | |
| Example 2 | 1^{st} sintered | 5 | 1.0 | 89 |
| | compact | | | |
| | 2^{nd} sintered | 20 | 4.0 | 84 |
| | compact | | | |
| Example 3 | 1^{st} sintered | 10 | 0.6 | 89 |
| | compact | | | |
| | 2^{nd} sintered | 20 | 4.0 | 84 |
| | compact | | | |
| Example 4 | 1^{st} sintered | 10 | 2.0 | 86 |
| | compact | | | |
| | 2^{nd} sintered | 22 | 6.0 | 83 |
| | compact | | | |
| Example 5 | 1^{st} sintered | 16 | 0.8 | 86 |
| | compact | | | |
| | 2^{nd} sintered | 22 | 6.0 | 83 |
| | compact | | | |

With the invention thus explained, it is apparent that various modifications and variations can be made without departing from the spirit of the present invention. It is therefore intended that the invention be limited only as recited in the appended claims.

I claim:

1. A Cobalt-containing tungsten-carbide sintered product, comprising:
first and second sintered compacts of Cobalt-containing tungsten-carbide which are integrally formed via a sintering process, one of said first and second sintered compacts having a hardness greater than that of the other one of said first and second sintered compacts.

2. The product of claim 1, wherein said first sintered compact contains an amount of Cobalt that is less than that of said second sintered compact.

3. The product of claim 1, wherein the tungsten-carbide contained in said first sintered compact has a particle size less than that of the tungsten-carbide contained in said second sintered compact.

4. A process for making a Cobalt-containing tungsten-carbide sintered product, comprising the steps of:
blending mixtures of Cobalt and tungsten-carbide powders;
compressing said mixtures of Cobalt and tungsten-carbide powders to form first and second green compacts; and
sintering said first and second green compacts to form first and second sintered compacts which are integrally formed, wherein one of said first and second sintered compacts has a hardness greater than that of the other one of said first and second sintered compacts.

5. The process of claim 4, wherein said first green compact contains an amount of Cobalt that is less than that of said second green compact.

6. The product of claim 4, wherein the tungsten-carbide contained in said first green compact has a particle size less than that of the tungsten-carbide contained in said second green compact.

7. The process of claim 4, further comprising a step of sintering said mixtures of Cobalt and tungsten-carbide powders before the step of compressing said mixtures of Cobalt and tungsten-carbide powders.

8. A Cobalt-containing tungsten-carbide punch, comprising:
first and second sintered compacts of Cobalt-containing tungsten-carbide which are integrally formed via a sintering process, one of said first and second sintered compacts having a hardness greater than that of the other one of said first and second sintered compacts.
